(19) United States
(12) Patent Application Publication
(10) Pub. No.: US 2024/0026887 A1
(43) Pub. Date: Jan. 25, 2024

(54) AXIAL FLOW FAN, AIR SENDING DEVICE, AND REFRIGERATION CYCLE APPARATUS

(71) Applicant: Mitsubishi Electric Corporation, Tokyo (JP)

(72) Inventors: Katsuyuki YAMAMOTO, Tokyo (JP); Takuya TERAMOTO, Tokyo (JP); Naho ADACHI, Tokyo (JP); Takashi IKEDA, Tokyo (JP); Takanori YOSHIDA, Tokyo (JP)

(21) Appl. No.: 18/043,161

(22) PCT Filed: Oct. 27, 2020
(86) PCT No.: PCT/JP2020/040276

§ 371 Date: Feb. 27, 2023

(51) Int. Cl. F04D 19/00; F24F 1/38; F04D 29/52; F04D 29/38

(52) U.S. Cl. CPC F04D 19/002; F24F 1/38; F04D 29/522; F04D 29/38

(57) ABSTRACT

In an axial flow fan, a plurality of blades are rotated about a rotation axis of the plurality of blades to generate an air current. Each of the plurality of blades includes a leading edge portion on a forward side in a rotation direction, and a trailing edge portion on a rearward side in the rotation direction. At the trailing edge portion of the blade, a first recessed portion is formed such that the first recessed portion is recessed toward the leading edge portion. At the leading edge portion of the blade, the second recessed portion is recessed toward the trailing edge portion. Ranges of the first recessed portion and the second recessed portion in a radial direction overlap with each other or completely coincide with each other.

### CROSS-REFERENCE TO RELATED APPLICATION

This application is a U.S. National Stage Application of International Application No. PCT/JP2020/040276 filed on Oct. 27, 2020, the contents of which are incorporated herein by reference.

### TECHNICAL FIELD

The present disclosure relates to an axial flow fan provided with a plurality of blades, an air sending device including the axial flow fan, and a refrigeration cycle apparatus including the air sending device.

### BACKGROUND

An existing axial flow fan includes a plurality of blades arranged along a circumferential surface of a cylindrical boss. In the existing axial flow fan, when a rotational force is applied to the boss, the blades are rotated, thereby sending fluid. In the axial flow fan, as the blades rotate, fluid that is present between the blades strikes surfaces of the blades. The pressure at the surfaces which the fluid strikes rises, and pushes and moves the fluid in a direction along a rotational axis that is a central axis about which the blades rotate.

As such an axial flow fan as described above, an axial flow fan has been proposed in which a recessed portion is formed at a trailing edge portion of each of blades such that the recessed portion is recessed toward a leading edge portion of the blade, and the leading edge portion of the blade is shaped such that the closer a portion of the leading edge portion to the outer peripheral side of the blade, the more forwardly the portion of the leading edge is projected in the rotational direction (see, for example, Patent Literature 1).

### PATENT LITERATURE

Patent Literature 1: Japanese Unexamined Patent Application Publication No. 2016-56772

In the axial flow fan described in Patent Literature 1, because of formation of the recessed portion formed at the trailing edge portion of the blade, the amount of work on the outer circumferential side is increased and larger than that at an apex of the recessed portion, thereby improving the fan efficiency. However, since the leading edge portion of the blade is shaped such that the closer a portion of the leading edge portion of the blade to the outer circumferential side, the more forwardly the portion of the leading edge of the blade is projected in the rotational direction than on the inner circumferential side. Thus, the closer the portion of the leading edge portion to the outer circumferential side, that is, the farther the portion of the leading edge portion from the inner circumferential side, the higher the wind velocity at the portion of the leading edge portion when air is sucked. When the wind velocity on the outer circumferential side increases as described above, an air current that flows from the position, in the radial direction, of the apex of the recessed portion at the leading edge portion onto the blade surface is guided by an air current having a high wind velocity on the outer circumferential side, and thus moves toward the outer circumferential side as the air current flows toward the trailing edge portion. In the vicinity of the trailing edge portion, the above air current joins an air current that flows from the outer circumferential side of the leading edge portion and then flows toward the trailing edge portion while flowing on the outer circumferential side. When these air currents join each other as described above, and the resultant air current flows out from the axial flow fan, the air current on the outer circumferential side has a great wind velocity value. When the air current strikes a structure located downward of the fan, a high resistance is generated, thereby increasing a noise level and reducing the efficiency.

### SUMMARY

The present disclosure is applied to solve the above problems, and relates to: an axial flow fan that reduces the amount by which air currents join each other on the outer circumferential side of a trailing edge portion and that thus decreases the noise level and improves the efficiency; an air sending device including the axial flow fan; and a refrigeration cycle apparatus including the air sending device.

An axial flow fan according to one embodiment of the present disclosure is an axial flow fan in which a plurality of blades are rotated about a rotation axis of the plurality of blades to generate an air current. Each of the plurality of blades includes a leading edge portion on a forward side in a rotation direction and a trailing edge portion on a rearward side in the rotation direction. At the trailing edge portion of the blade, a first recessed portion is formed such that the first recessed portion is recessed toward the leading edge portion. At the leading edge portion of the blade, a second recessed portion is formed such that the second recessed portion is recessed toward the trailing edge portion. Ranges of the first recessed portion and the second recessed portion in a radial direction overlap with each other or completely coincide with each other.

An air sending device according to another embodiment of the present disclosure includes: the axial flow fan having the above configuration; a drive source configured to apply a drive force to the axial flow fan; and a casing housing e the axial flow fan and the drive source.

A refrigeration cycle apparatus according to a further embodiment of the present disclosure includes: the air sending device having the above configuration; and a refrigerant circuit including a condenser and an evaporator. The air sending device sends air to at least one of the condenser and the evaporator.

According to the embodiments of the present disclosure, the ranges of the first recessed portion and the second recessed portion in the radial direction overlap with each other or completely coincide with each other, whereby at the leading edge portion, the wind velocity value of an air current that flows onto the blade surface from the position, in the radial direction, of the apex of the second recessed portion and that flows toward the trailing edge portion can be reduced. As a result, it is possible to reduce the amount by which the air currents join each other on the outer circumferential side of the trailing edge portion, and thus reduce the noise level and improve the efficiency.

### BRIEF DESCRIPTION OF DRAWINGS

FIG. 1 is a perspective view illustrating a schematic configuration of an axial flow fan according to Embodiment 1.

FIG. 2 is a plan view of a blade as illustrated in FIG. 1 as the blade is viewed in the axial direction of the rotation axis.

FIG. 3 is an explanatory view for a range of a first recessed portion of the blade in a radial direction in Embodiment 1.

FIG. 4 is an explanatory view for a range of a second recessed portion of the blade in the radial direction in Embodiment 1.

FIG. 5 is a plan view of a blade of an existing axial flow fan as a blade is viewed in an axial direction of the rotation axis.

FIG. 6 is an explanatory view of an air current at an existing axial flow fan.

FIG. 7 is an explanatory view of an air current on a surface of the blade of the axial flow fan according to Embodiment 1.

FIG. 8 is a plan view of a blade of an axial flow fan according to Embodiment 2 as the blade is viewed in the axial direction of the rotation axis.

FIG. 9 is a plan view of a blade of an axial flow fan according to Embodiment 3 as the blade is viewed in the axial direction of the rotation axis.

FIG. 10 is a projection view of an axial flow fan according to Embodiment 4 as the axial flow fan is rotated and projected onto a meridional plane.

FIG. 11 is a projection view of the existing axial flow fan which is rotated and projected onto the meridional plane.

FIG. 12 illustrates a modification of the axial flow fans according to Embodiments 1 to 4.

FIG. 13 is a schematic diagram of a refrigeration cycle apparatus according to Embodiment 5.

FIG. 14 is a perspective view of an outdoor unit according to Embodiment as the outdoor unit is viewed from an air outlet side.

FIG. 15 is a schematic cross-sectional view of the outdoor unit according to Embodiment 5.

FIG. 16 illustrates the outdoor unit according to Embodiment 5, with a fan grille removed from the outdoor unit.

FIG. 17 illustrates an internal configuration of the outdoor unit according to Embodiment 5, with the fan grille, a front panel, and other parts removed from the outdoor unit.

### DETAILED DESCRIPTION

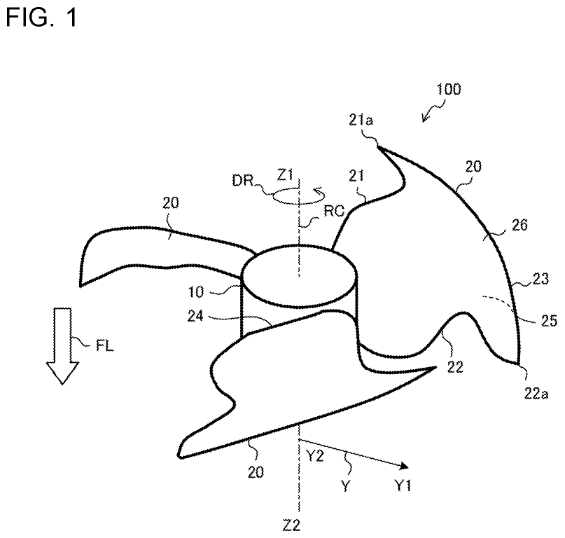

An axial flow fan, an air sending device and a refrigeration cycle apparatus according to the embodiments will be described with reference to the drawings. It should be noted that in figures including FIG. 1 which will be referred to below, relationships in size, shape, etc., between components may differ from those between actual components. In each of the figures, components that are the same as or equivalent to those in a previous figure or previous figures are denoted by the same reference signs, and the same is true of the entire text of the specification. Furthermore, in order that the embodiments be easily understood, terms related to directions (for example, “up,” “down,” “right,” “left,” “front,” and “rear”) may be appropriately used. These terms are used as a matter of convenience for explanation, and are not intended to limit the location and orientation of each of devices or components. In the following descriptions, the direction in which the rotation axis of the axial flow fan extends will be referred to as “axial direction,” the direction perpendicular to the axial direction will be referred to as “radial direction,” and the direction of rotation around the rotation axis will be referred to “circumferential direction.” In addition, a side in the radial direction that is closer to the rotation axis will be referred to as “inner circumferential side,” and a side in the radial direction that is further from the rotation axis will be referred to as “outer circumferential side.”

### Embodiment 1

### Axial Flow Fan 100

FIG. 1 is a perspective view illustrating a schematic configuration of an axial flow fan 100 according to Embodiment 1. It should be noted that a rotation direction DR indicated by an arrow in FIG. 1 is a rotation direction DR of the axial flow fan 100. A direction FL indicated by an outlined arrow in FIG. 1 is a flow direction FL of an air current. In the flow direction FL of the air current, a Z1 side with reference to the axial flow fan 100 is an upstream side of the air current with reference to the axial flow fan 100, and a Z2 side with reference to the axial flow fan 100 is a downstream side of the air current with reference to the axial flow fan 100. That is, the Z1 side is an air suction side with reference to the axial flow fan 100, and the Z2 side is an air discharge side with reference to the axial flow fan 100. Furthermore, a Y-axis represents a radial direction with reference to a rotation axis RC corresponding to a central axis about which the axial flow fan 100 rotates. A Y2 side with reference to the axial flow fan 100 is an inner circumferential side of the axial flow fan 100, and a Y1 side with reference to the axial flow fan 100 is an outer circumferential side of the axial flow fan 100.

The axial flow fan according to Embodiment 1 will be described below with reference to FIG. 1. The axial flow fan 100 is used in, for example, an air-conditioning apparatus or a ventilating apparatus. As illustrated in FIG. 1, the axial flow fan 100 includes a boss 10 provided around the rotation axis RC, and a plurality of blades 20 connected to the boss 10. The axial flow fan 100 is rotated about the rotation axis RC to generate an air current.

### Boss 10

The boss 10 is located around the rotation axis RC. The boss 10 rotates about the rotation axis RC. The rotation direction DR of the axial flow fan 100 is a counterclockwise direction indicated by the arrow in FIG. 1. However, the rotation direction DR of the axial flow fan 100 is not limited to the counterclockwise direction, and the angle at which the blades 20 are attached to the boss 10 may be changed such that the axial flow fan 100 is configured to rotate in the clockwise direction. The boss is connected to a rotation shaft of a drive source such as a motor (not illustrated). For example, the boss 10 may be formed into a cylindrical shape or a plate-like shape. It suffices that the boss 10 is connected to the rotation shaft of the drive source as described above, and the shape of the boss 10 is not particularly limited.

### Blade 20

Each of a plurality of blades 20 extends radially outward from the boss 10 in the radial direction. The plurality of blades 20 are spaced from each other in the circumferential direction. Regarding Embodiment 1, it is illustrated by way of example that three blades 20 are provided. However, the number of blades 20 is not limited to three. One of surfaces of each blade 20 that is located on the upstream side (Z1 side) in the flow direction FL of the air current will be referred to as “suction surface 26,” and the other surface of the blade 20 that is located on the downstream side (Z2 side) in the flow direction FL of the air current will be referred to as “pressure surface 25.” In a direction perpendicular to the plane of FIG. 1, the front surface of the blade 20 corresponds to the suction surface 26, and the back surface thereof corresponds to the pressure surface 25. The blade 20 is warped in such a manner as to protrude forwardly from a suction surface side where the suction surface 26 is located.

The blade 20 includes a leading edge portion 21, a trailing edge portion 22, an outer circumferential edge portion 23, and an inner circumferential edge portion 24. The leading edge portion 21 is located on the upstream side of an air current to be generated (which corresponds to the Z1 side), and is formed on a front surface of the blade 20 in the rotation direction DR. That is, the leading edge portion 21 is located in front of the trailing edge portion 22 in the rotation direction DR. The trailing edge portion 22 is located on the downstream side of the air current to be generated (which corresponds to the Z2 side), and is formed on a rear side of the blade 20 in the rotation direction DR. That is, the trailing edge portion 22 is located in back of the leading edge portion 21 in the rotation direction DR. The axial flow fan 100 includes the leading edge portion 21 that serves as a blade end portion facing forward in the rotation direction DR of the axial flow fan 100, and includes the trailing edge portion 22 that serves as a blade end portion located opposite to the leading edge portion 21 in the rotation direction DR.

The outer circumferential edge portion 23 extends in a front-back direction in such a manner as to arc and connect an outermost circumferential portion of the leading edge portion 21 and an outermost circumferential portion of the trailing edge portion 22. The outer circumferential edge portion 23 is formed in the shape of an arc curved outward in the radial direction. The outer circumferential edge portion 23 is located at an end portion of the axial flow fan 100 in the radial direction (Y-axis direction). The inner circumferential edge portion 24 extends in such a manner as to arc in the front-back direction and between an innermost circumferential portion of the leading edge portion 21 and an innermost circumferential portion of the trailing edge portion 22. The inner circumferential edge portion 24 of the blade 20 is connected to an outer circumference of the boss 10.

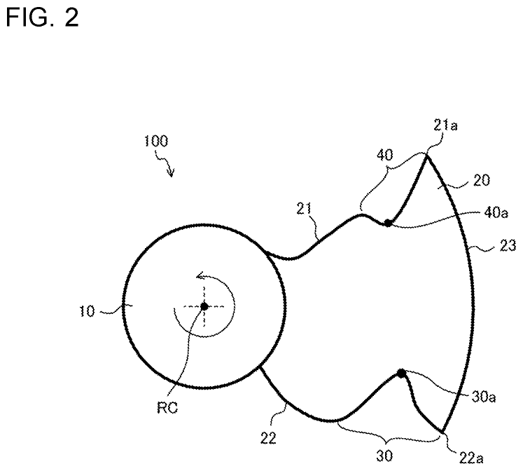

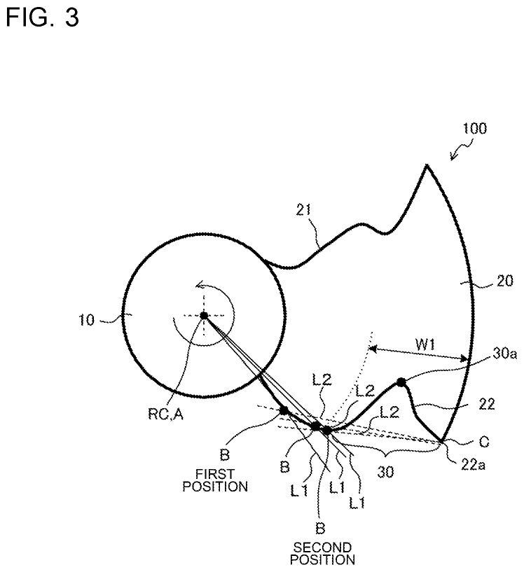

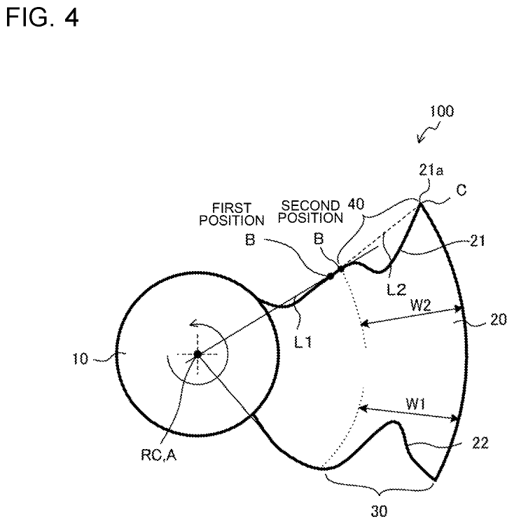

FIG. 2 is a plan view of the blade 20 as illustrated in FIG. 1, as the blade 20 is viewed in the axial direction of the rotation axis RC. FIG. 3 is an explanatory view for a range of a first recessed portion 30 of the blade 20 in the radial direction in Embodiment 1. FIG. 4 is an explanatory view for a range of a second recessed portion 40 of the blade 20 in the radial direction in Embodiment 1.

As illustrated in FIG. 2, the first recessed portion 30 is formed at the trailing edge portion 22 of the blade 20, and is recessed toward the leading edge portion 21. In addition, the second recessed portion 40 is formed at the leading edge portion 21 of the blade 20, and is recessed toward the trailing edge portion 22.

The range of the first recessed portion 30 in the radial direction will be described with reference to FIG. 3. In a plan view of the blade 20 that is obtained as viewed in the axial direction of the rotation axis RC, a point A is the point at the rotation axis RC, and points B are points that form the trailing edge portion 22. In this case, straight lines L1 are straight lines (solid straight lines in FIG. 3) that connect the point A and the points B. The points B are located at different positions of the trailing edge portion 22 from the inner circumferential end to the outer circumferential end and. The straight lines L1 includes a straight line L1 that is a line tangent to the trailing edge portion 22 and thus does not intersect the trailing edge portion 22. The position of the point B located on this straight line L1 will be referred to as a first position.

Furthermore, a point C is an outer circumferential end 22a of the trailing edge portion 22, and the points B are the points that form the trailing edge portion 22. In this case, straight lines L2 are straight lines (dotted straight lines in FIG. 3) that connect the point C and the points B. The points B are located at the different positions of the trailing edge portion 22 from the inner circumferential end to the outer circumferential end. The straight lines L2 include a straight line L2 that is a line tangent to the trailing edge portion 22 and thus does not intersect the trailing edge portion 22. The position of the point B located on this straight line L2 is defined as a second position.

A range W1 in the radial direction between the second position, which is closer to the outer circumferential side than the first position, and part of the first recessed portion that protrudes rearward in the rotation direction on the outer circumferential side relative to an apex 30a of the first recessed portion 30, that is, the outer circumferential end 22a of the trailing edge portion 22 in this example, is defined as the range of the first recessed portion 30 in the radial direction.

The range of the second recessed portion 40 in the radial direction will be described with reference to FIG. 4. In a plan view of the blade 20 that is obtained as viewed in the axial direction of the rotation axis RC, the point A is the point at the rotation axis RC, and the points B are the points that form the leading edge portion 21. In this case, straight lines L1 are straight lines (solid straight lines in FIG. 4) that connect the point A and the points B. The points B are located at different positions of the leading edge portion 21 from the inner circumferential end to the outer circumferential end. The straight lines L1 include a straight line L1 that is a line tangent to the leading edge portion 21 and thus does not intersect the leading edge portion 21. The position of the point B located on this straight line L1 is a first position.

Furthermore, the point C is an outer circumferential end 21a of the leading edge portion 21, and the points B are the points that form the leading edge portion 21. In this case, straight lines L2 are straight lines (dotted straight lines in FIG. 4) that connect the point C and the points B. The points B are located at different positions of the leading edge portion 21 from the inner circumferential end to the outer circumferential end. The straight lines L2 include a straight line L2 that is a line tangent to the leading edge portion 21 and thus does not intersect the leading edge portion 21. The position of the point B located on this straight line L2 is a second position.

A range W2 in the radial direction between the second position, which is closer to the outer circumferential side than the first position, and the outer circumferential end 21a of the leading edge portion 21 is defined as the range of the second recessed portion 40 in the radial direction. The range W2 of the second recessed portion 40 in the radial direction overlaps with or completely coincides with the radial range W1 of the first recessed portion 30 in the radial direction. That is, the ranges of the first recessed portion 30 and the second recessed portion 40 in the radial direction overlap with or completely coincide with each other.

Next, it will be described what advantages are obtained by the above configuration.

First of all, the configuration of an existing axial flow fan will be described as a comparative example.

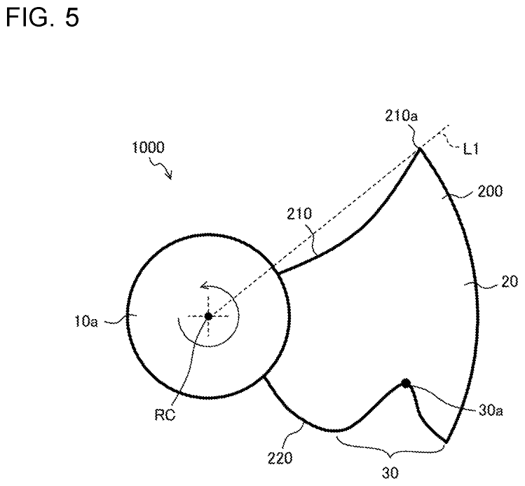

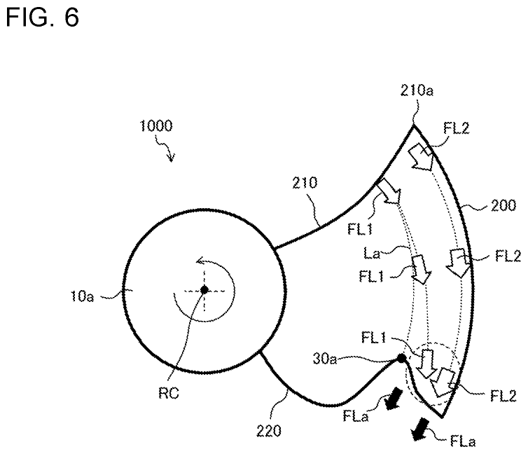

FIG. 5 is a plan view of a blade 200 of an existing axial flow fan 1000 as the blade 200 is viewed in the axial direction of the rotation axis RC. FIG. 6 is an explanatory view of an air current at the existing axial flow fan 1000. In FIG. 6, the thickness of each of arrows indicates how great a wind velocity value is.

The configuration of the blade 200 of the existing axial flow fan 1000 is equivalent to a configuration in which the second recessed portion 40 as illustrated in FIG. 2 is removed from the blade 20 as illustrated in FIG. 2. A leading edge portion 210 of the blade 200 is located rearward in the rotation direction relative to a straight line L1 connecting an outer circumferential end 210a of the leading edge portion 210 and the rotation axis RC, and is formed into an arc shape such that the leading edge portion 210 is recessed toward a trailing edge portion 220. Part of the leading edge portion 210 that is closer to the outer circumferential side is located more forwardly in the rotation direction than part of the leading edge portion 210 that is closer to the inner circumferential side, that is, a boss 10a.

In the existing blade 200, part of the leading edge portion 210 that is closer to the outer circumferential side is located more forwardly in the radial direction than part of the leading edge portion 210 that is closer to the inner circumferential side. Thus, the wind velocity of air at the leading edge portion 210 at the time of sucking the air is higher on the outer circumferential side than on the inner circumferential side. Therefore, as an air current FL1 that flows from the leading edge portion 210 to the position, in the radial direction, of the apex of the first recessed portion 30 flows over the blade surface toward the trailing edge portion 220, this air current FL1 is guided by an air current having a higher wind velocity on the outer circumferential side, and thus flows toward the outer circumferential side. An arc La in FIG. 6 indicates the arc of a circle about the rotation axis RC that passes through the apex 30a of the first recessed portion 30. It can be seen that as the air current FL1 flows from the leading edge portion 210 toward the trailing edge portion 220, this air current FL1 moves away from the arc La toward the outer circumferential side.

As described above, as the air current FL1 flows from the leading edge portion 210 toward the trailing edge portion 220, this air current FL1 moves toward the outer circumferential side. Thus, in the vicinity of the trailing edge portion 220, the air current FL1 joins an air current FL2 that flows from the outer circumferential side of the leading edge portion 210 and then flows toward the trailing edge portion 220, while flowing on the outer circumferential side. As a result, the wind velocity value of an air current FLa discharged from the axial flow fan 1000 has a greater wind velocity value on the outer circumferential side than a wind velocity value on the inner circumferential side. Therefore, when the air current FLa discharged from the axial flow fan 1000 strikes a structure located downstream of the fan, a high resistance is generated, thereby increasing the noise level and decreasing the efficiency.

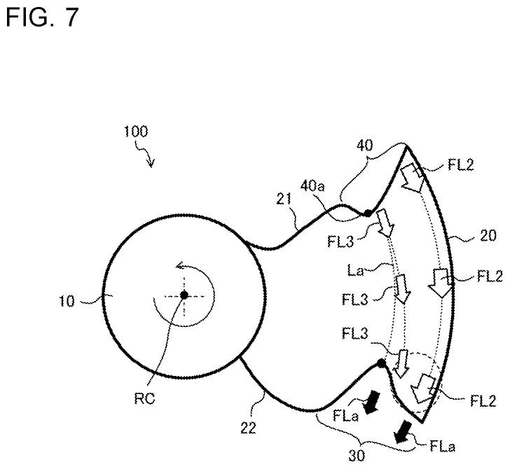

FIG. 7 is an explanatory view of an air current on a surface of the blade 20 of the axial flow fan 100 according to Embodiment 1. In FIG. 7, the thickness of each of arrows indicates how great the wind velocity value is.

The blade 20 of Embodiment 1 has the second recessed portion 40 that is formed at the leading edge portion 21 at such a position that the range of the second recessed portion 40 in the radial direction overlaps with that of the first recessed portion 30, in addition to the first recessed portion 30 formed at the trailing edge portion 22. Thus, the position of an apex 40a of the second recessed portion 40 in the radial direction is located within the range of the first recessed portion 30 in the radial direction. Therefore, as the blade 20 is viewed in the axial direction, the length of the blade 20 in the circumferential direction at the position of the apex 40a of the second recessed portion 40 in the radial direction is smaller than that of the existing blade 200.

The circumferential length of the blade 20 is reduced, and thus at the leading edge portion 21, the wind velocity value of an air current FL3 that flows onto the blade surface from the position, in the radial direction, of the apex of the second recessed portion 40 and then flows toward the trailing edge portion 22 is reduced to a smaller value than that at the existing blade 200. Therefore, the wind velocity value can be decreased when the air current FL3 moves toward the outer circumferential side as this air current FL3 flows from the leading edge portion 21 toward the trailing edge portion 22. Thus, it is possible to reduce the wind velocity value when the air current FL3 joins the air current FL2 that flows from the outer circumferential side of the leading edge portion 21 to the blade and then flows toward the outer circumferential side of the trailing edge portion 22. As a result, of the air current FLa discharged from the axial flow fan 100, an air current that flows on the outer circumferential side can be further reduced in wind velocity value, as compared with the existing blade 200. Thus, it is possible to reduce a resistance that is generated when the air current FLa discharged from the axial flow fan 100 strikes the structure located downstream of the fan, whereby the noise level can be decreased and the efficiency can be improved.

As described above, in the axial flow fan 100 of Embodiment 1, the blade 20 includes the leading edge portion 21 on the forward side in the rotation direction, and the trailing edge portion 22 on the rearward side in the rotation direction. The first recessed portion 30 is formed at the trailing edge portion 22 of the blade 20, and is recessed toward the leading edge portion 21. The second recessed portion 40 is formed at the leading edge portion 21 of the blade 20, and is recessed toward the trailing edge portion 22. As the blade 20 is viewed in the axial direction of the rotation axis RC, the ranges of the first recessed portion 30 and the second recessed portion 40 in the radial direction overlap with or completely coincide with each other.

As described above, the ranges of the first recessed portion 30 and the second recessed portion 40 in the radial direction overlap with or completely coincide with each other. It is therefore possible to reduce the wind velocity value of the air current FL3 that flows onto the blade surface from the position, in the radial direction, of the apex of the second recessed portion 40 at the leading edge portion 21 and then flows toward the trailing edge portion 22. As a result, it is possible to reduce the amount by which the air currents join each other on the outer circumferential side of the trailing edge portion 22, and thus decrease the noise level and improve the efficiency.

### Embodiment 2

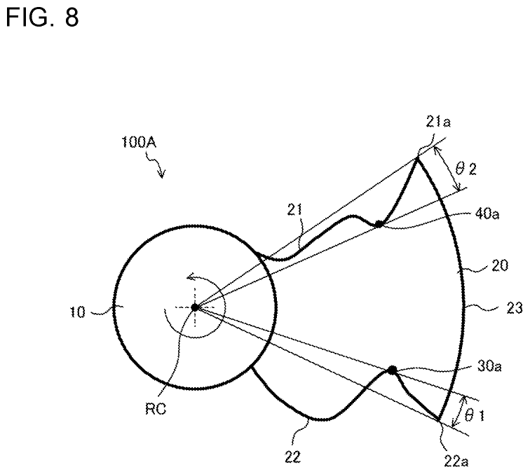

FIG. 8 is a plan view of the blade 20 of an axial flow fan 100A according to Embodiment 2 as the blade 20 is viewed in the axial direction of the rotation axis RC. The axial flow fan 100A according to Embodiment 2 will be described by referring mainly to the differences between the axial flow fan 100A and the axial flow fan 100 according to Embodiment 1. Regarding Embodiment 2, configurations that are the same as those in Embodiment 1 will not be described.

The blade 20 of Embodiment 2 satisfies the relationship “θ2>θ1”, where an angle 81 is an angle between a straight line connecting the rotation axis RC and the outer circumferential end 22a of the trailing edge portion 22 and a straight line connecting the rotation axis RC and the apex 30a of the first recessed portion 30, and an angle 82 is an angle between a straight line connecting the rotation axis RC and the outer circumferential end 21a of the leading edge portion 21 and a straight line connecting the rotation axis RC and the apex 40a of the second recessed portion.

When the fan is driven, the blade 20 is subjected to a resistance generated by an air current, and is thus deformed. Specifically, in the case where the leading edge portion 21 and the trailing edge portion 22 are both formed to have respective recessed portions, the blade is deformed from each of the recessed portions such that part of the blade that is located closer to the outer circumferential side than the recessed portion is bent downward or upward.

If θ2=θ1, that is, if the amount of protrusion of the leading edge portion 21 in the rotation direction from the apex of the recessed portion to the outer circumferential end is equal to the amount of protrusion of the trailing edge portion 22 in the rotation direction from the apex of the recessed portion to the outer circumferential end, the leading edge portion 21 is deformed in a similar manner to the deformation of the trailing edge portion 22, as a result of which the blade will be greatly swung as a whole.

In contrast, in the case where θ2>θ1 as in Embodiment 2 and the amount of protrusion at the leading edge portion 21 is made to differ from that at the trailing edge portion 22, the manner in which the leading edge portion 21 is deformed is different in balance from the manner in which the trailing edge portion 22 is deformed, thereby dampening swinging of the blade as a whole. That is, generation of noise caused by swinging or similar factors can be reduced.

Regarding Embodiment 2, it is described above that θ2>θ1 is satisfied. However, θ2<θ1 may also be satisfied. In this case also, generation of noise caused by swinging or similar factors can be reduced. It should be noted that in the case where θ2>θ1, the amount of protrusion of the trailing edge portion 22 in the rotation direction from the apex 30a of the first recessed portion 30 to the outer circumferential end 22a is small, and thus the degree to which the trailing edge portion 22 is deformed is also small. Therefore, deformation of the trailing edge portion 22 of the blade can be reduced, and it is therefore possible to reduce transmission of turbulence to an air current that flows out from the trailing edge portion 22, and to decrease the noise level. In contrast, in the case where θ2<θ1, the amount of protrusion of the leading edge portion 21 in the rotation direction from the apex 40a of the second recessed portion 40 to the outer circumferential end 21a is small, and the degree to which the leading edge portion 21 is deformed is thus small. Thus, since deformation of the leading edge portion 21 of the blade can be reduced, an air current that flows to the leading edge portion 21 is stabilized, transmission of turbulence to the air current at the leading edge portion 21 is reduced, and the noise level can be reduced.

As described above, according to Embodiment 2, it is possible to obtain the same advantages as in Embodiment 1, and reduce generation of noise that is caused by swinging or similar factors, since θ2>θ1 or θ2<θ1 is satisfied.

### Embodiment 3

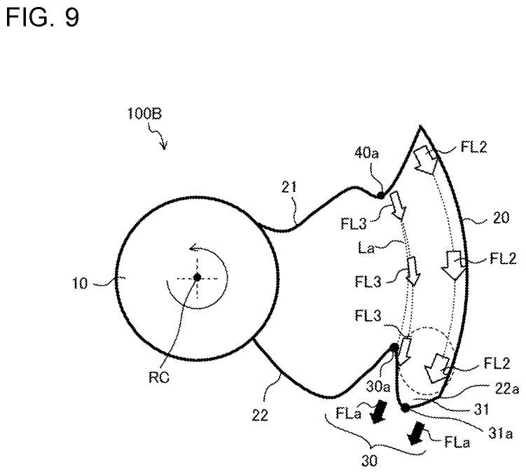

FIG. 9 is a plan view of the blade 20 of an axial flow fan 1008 according to Embodiment 3 as the blade 20 is viewed in the axial direction of the rotation axis RC. The axial flow fan 1008 according to Embodiment 3 will be described by referring mainly to the differences between the axial flow fan 1008 and the axial flow fan 100 according to Embodiment 1, etc. Regarding Embodiment 3, configurations that are the same as those in Embodiment 1 will not be described.

The blade 20 of the axial flow fan 1008 of Embodiment 3 includes a first protruding portion 31 that protrudes rearward in the rotation direction and is located closer to the outer circumferential side of the trailing edge portion 22 than the apex 30a of the first recessed portion 30. An apex 31a of the first protruding portion 31 is located closer to the inner circumferential side of the trailing edge portion 22 than the outer circumferential end 22a, and is also located more rearward in the rotation direction than the outer circumferential end 22a of the trailing edge portion 22.

Next, the advantages of the above configuration will be described.

The first protruding portion 31 is provided closer to the outer circumferential side of the trailing edge portion 22 than the apex 30a of the first recessed portion 30, whereby that the blade 20 is extended in the rotation direction because of provision of the first protruding portion 31. An air current tends to flow to part of the blade 20 that extends rearward long in the rotation direction. Thus, the air current FL3 that flows onto the blade surface from the position, in the radial direction, of the apex of the second recessed portion 40 of the leading edge portion 21 and then flows toward the trailing edge portion 22 is guided toward the apex of the first protruding portion 31. That is, the air current FL3 is guided to a position closer to the inner circumferential side than in the case where the first protruding portion 31 is not provided (see FIG. 7). From the comparison between FIG. 9 and FIG. 7, it can be seen that the air current FL3 as illustrated in FIG. 9 flows closer to the arc La, as the air current FL 3 flows toward the trailing edge portion 22, than the air current FL3 as illustrated in FIG. 7.

Thus, the air current is made uniform on part of the blade surface that is closer to the outer circumferential side than the apex 30a of the first recessed portion 30. Thus, it is possible to reduce the amount by which the air current FL3 joins the air current FL2 that flows on the outer circumferential side, and reduce the wind velocity value of the air current FLa that flows out from the outer circumferential side. It is therefore possible to reduce a resistance that is generated when the air current FLa discharged from the axial flow fan 100 strikes the structure located downstream of the fan, thus decreasing the noise level, and improving the efficiency.

As described above, according to Embodiment 3, it is possible to obtain the same advantages as in Embodiment 1 and in addition the following advantages. That is, since the first protruding portion 31 is provided closer to the outer circumferential side of the trailing edge portion 22 than the apex 30a of the first recessed portion 30, it is possible to reduce a resistance that is generated when the air current FLa discharged from the axial flow fan 100 strikes the structure located downstream of the fan, and thus decrease the noise level and improve the efficiency.

### Embodiment 4

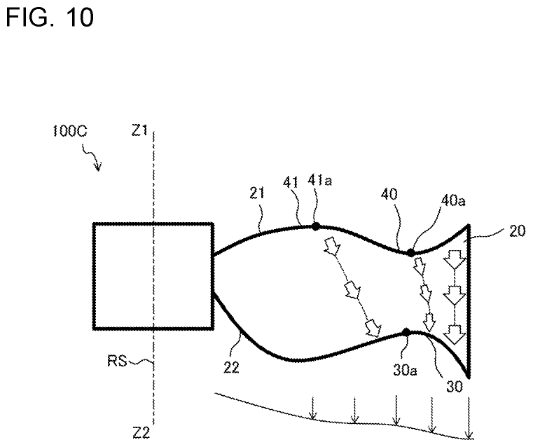

FIG. 10 illustrates a projection view of an axial flow fan 100C according to Embodiment 4 in which the axial flow fan 100C is rotated and projected onto a meridional plane, and also illustrates a wind velocity distribution at the position of the blade 20 in the radial direction. The axial flow fan 100C according to Embodiment 4 will be described by referring mainly to the differences between the axial flow fan 100C and the axial flow fan 100 according to Embodiment 1. Regarding Embodiment 4, configurations that are the same as those in Embodiment 1 will not be described.

In the shape of the blade 20 in Embodiment 4 that is rotated and projected onto the meridional plane that is a plane including the rotation axis RC, the blade 20 includes a second protruding portion 41 that protrudes toward the upstream side (Z1 side) of the air current and that is located closer to the inner circumferential side than the apex 30a of the first recessed portion 30 and the apex 40a of the second recessed portion 40. An apex 41a of the second protruding portion 41 is located closer to the inner circumferential side than the apex 30a of the first recessed portion 30 and the apex 40a of the second recessed portion 40.

The advantages of the above configuration will be described.

First of all, the configuration of the existing axial flow fan will be described as that of a comparative example.

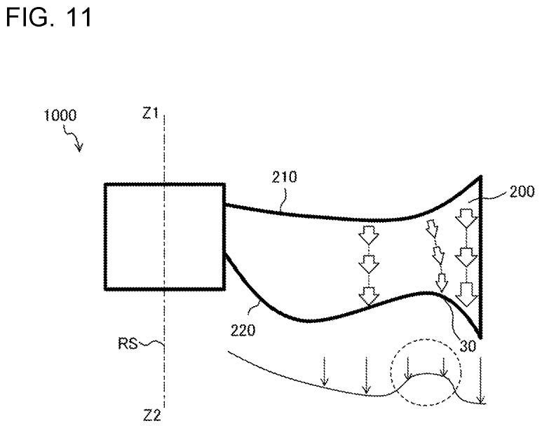

FIG. 11 illustrates a projection view of the existing axial flow fan 1000 which is rotated and projected onto the meridional plane, and also illustrates a velocity distribution at the position of the blade 200 in the radial direction. In the projection view of FIG. 11, the thickness of each of arrows indicates how great the wind velocity value is. In the wind velocity distribution in FIG. 11, the length of each of arrows indicates how great the wind velocity value is.

In the shape of the blade 200 which is rotated and projected onto the meridional plane, the blade 200 of the existing axial flow fan 1000 does not include the second protruding portion 41, and the leading edge portion 210 has an arc shape from the inner circumferential side toward the outer circumferential side. The area of the blade between the leading edge portion 210 and the trailing edge portion 220 is reduced by the area by which the trailing edge portion 220 is recessed by formation of the first recessed portion 30, and an air current that flows from the leading edge portion 210 onto the blade surface, as described above, flows toward the outer circumferential side of the trailing edge portion 220. Thus, as indicated in an area surrounded by a dotted circle in FIG. 11, the wind velocity value of an air current that flows out from part of the blade 200 in which the first recessed portion 30 is formed is smaller than the wind velocity value of an air current that flows out from the other portion of the blade 200 in which the first recessed portion 30 is not formed. Therefore, the wind velocity value of the air current discharged from the axial flow fan 1000 varies depending on the position in the radial direction. Because of the difference in wind velocity between different positions in the radial direction, an air current that flows in a different direction (hereinafter, referred to as “secondary flow”) from an intended flow direction is generated. This secondary flow can cause a shortage of an air volume, or can cause generation of an eddy, thereby increasing the noise level and reducing the efficiency.

In contrast, in the blade 20 of the axial flow fan 100C of Embodiment 4, the second protruding portion 41 is provided closer to the inner circumferential side than the apex 30a of the first recessed portion 30 and the apex 40a of the second recessed portion 40, whereby an air current discharged from the axial flow fan 100C flows in the following manner. As illustrated in FIG. 10, on the upstream side (Z1 side), part of the leading edge portion 21 in which the second protruding portion 41 is formed is located upstream of another portion of the leading edge portion 21 in which the second recessed portion 40 is formed. Because of the above configuration, the air current flows onto the second protruding portion 41 earlier than onto the other portion, and the second protruding portion 41 is more easily subjected to a centrifugal force than the other portion. Therefore, an air current that flows onto the blade surface from the second protruding portion 41 is subjected to the centrifugal force, and is thus guided toward the outer circumferential side as this air current flows toward the trailing edge portion 22 to compensate for the decrease in the wind velocity value of the air current flowing out from the part of the leading edge portion 21 in which the second recessed portion 40 is formed. In such a manner, since the decrease in the wind velocity value of an air current that flows out from the above part of the leading edge portion 21 is compensated for, a uniform wind velocity distribution in the radial direction can be obtained. As a result, it is possible to reduce the secondary flow, increase the air volume, decrease the noise level, and improve the efficiency.

As described above, according to Embodiment 4, it is possible to obtain the same advantages as in Embodiment 1, and in addition the following advantages. That is, the blade 20 includes the second protruding portion 41 that protrudes toward the upstream side and is closer to the inner circumferential side than the apex 30a of the first recessed portion 30 and the apex 40a of the second recessed portion 40, whereby it is possible to reduce the secondary flow, increase the air volume, decrease the noise level, and improve the efficiency.

The embodiments of the axial flow fan are described above. However, the descriptions concerning these embodiments are not limiting, and the embodiments can be appropriately combined. For example, Embodiments 1 and 3 may be combined, Embodiments 1 to 3 may be combined, Embodiments 1 and 4 may be combined, and Embodiments 1 to 4 may be combined.

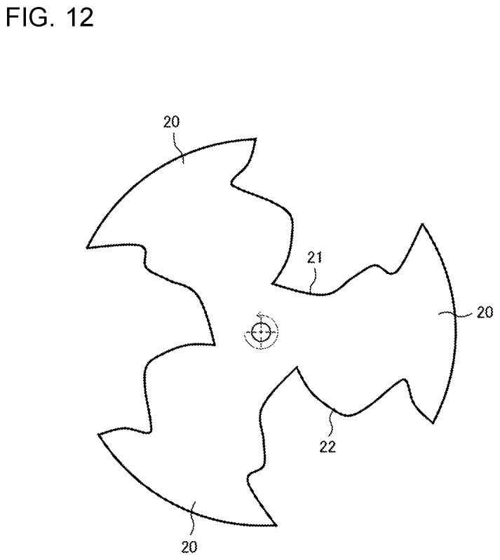

Furthermore, the above descriptions are made by referring to by way of example the configuration in which, for example, the axial flow fan 100 includes the boss 10. However, a configuration in which, for example, the axial flow fan 100 does not include the boss 10 as illustrated in FIG. 12 may be applied.

FIG. 12 illustrates a modification of the axial flow fans according to Embodiments 1 to 4.

The axial flow fan as illustrated in FIG. 12 is a so-called bossless fan that does not include the boss 10 as illustrated in FIG. 1, in which the leading edge side and the trailing edge side of any adjacent ones of a plurality of blades 20 are connected in such a manner as to form a continuous surface without the boss 10. The present disclose also covers this type of bossless fan as an axial flow fan according to the present disclosure.

### Embodiment 5

Regarding Embodiment 5, the following description is made with respect to the case where, for example, the axial flow fan 100 according to each of Embodiments 1 to 4 is applied to an outdoor unit 50 of a refrigeration cycle apparatus 70 that serves as an air sending device.

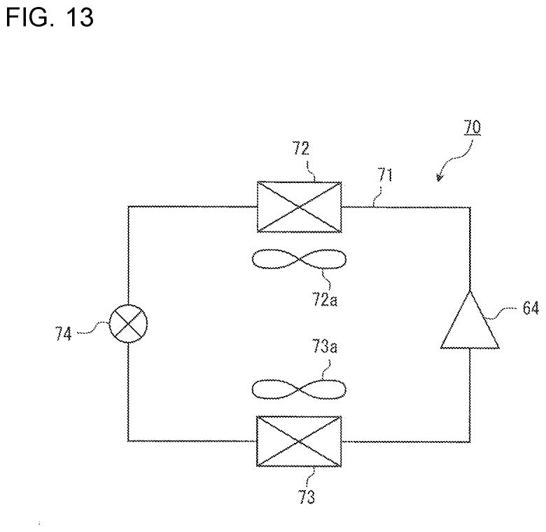

FIG. 13 is a schematic diagram of a refrigeration cycle apparatus 70 according to Embodiment 5. The following description is made with respect to the case where the refrigeration cycle apparatus 70 is used for air-conditioning. However, the refrigeration cycle apparatus 70 is not limited to a refrigeration cycle apparatus for use in air-conditioning. The refrigeration cycle apparatus 70 is used for refrigeration or air-conditioning in, for example, a refrigerator or a freezer, or an automatic dispenser, an air-conditioning apparatus, a refrigeration apparatus, a water heater, or other kinds of apparatuses.

As illustrated in FIG. 13, the refrigeration cycle apparatus 70 includes a refrigerant circuit 71 in which a compressor 64, a condenser 72, an expansion valve 74, and an evaporator 73 are sequentially connected by refrigerant pipes. In the condenser 72, a condenser fan 72a is provided to send air for use in heat exchange to the condenser 72. In the evaporator 73, an evaporator fan 73a is provided to send air for use in heat exchange to the evaporator 73. At least one of the condenser fan 72a and the evaporator fan 73a is the axial flow fan 100 according to any one of Embodiments 1 to 4 described above. It should be noted that the refrigeration cycle apparatus 70 may be provided with a flow switching device such as a four-way valve in the refrigerant circuit 71 to switch an operation between a heating operation and a cooling operation. The flow switching device is configured to switch the flow direction of refrigerant between a plurality of flow directions.

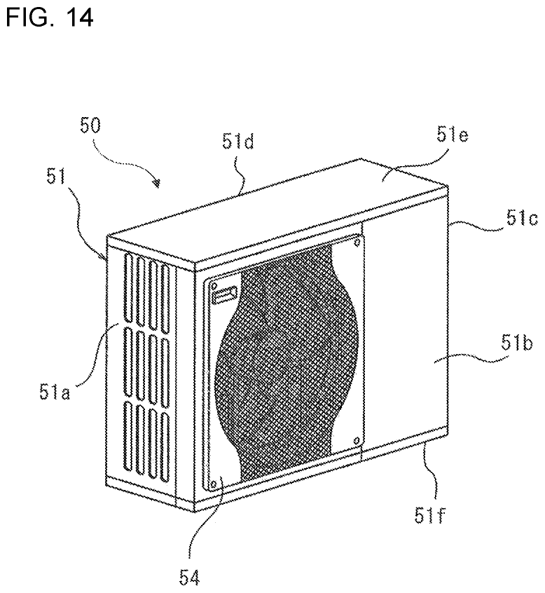

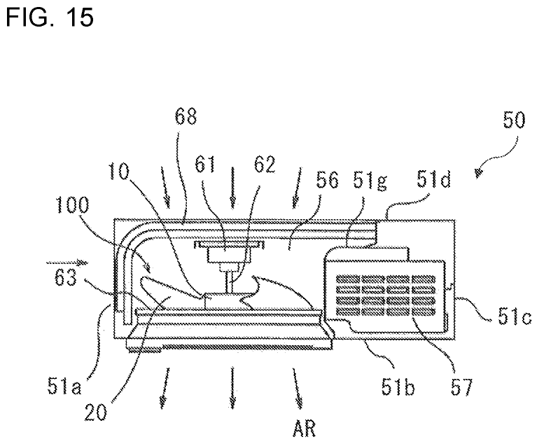

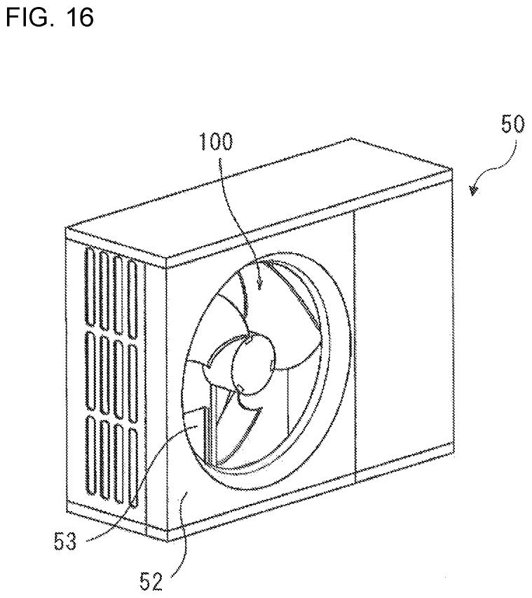

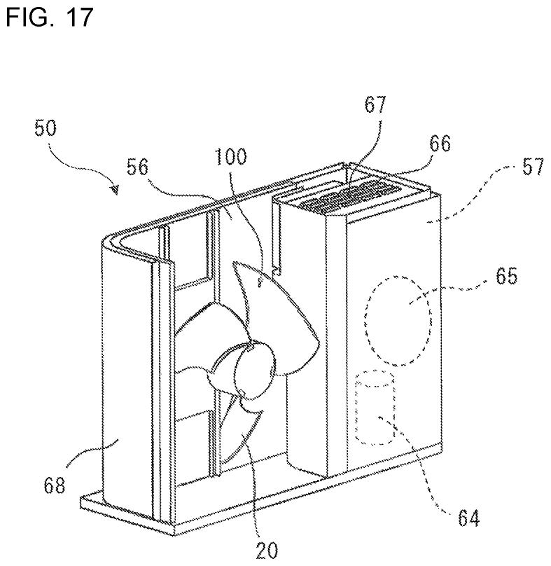

FIG. 14 is a perspective view of the outdoor unit 50 according to Embodiment 5 as the outdoor unit 50 is viewed from an air outlet side. FIG. 15 is a schematic cross-sectional view of the outdoor unit 50 according to Embodiment 5. FIG. 16 illustrates the outdoor unit 50 according to Embodiment 5, with a fan grille 54 removed from the outdoor unit 50. FIG. 17 illustrates an internal configuration of the outdoor unit 50 according to Embodiment 5, with the fan grille 54, a front panel, and other parts removed from the outdoor unit 50.

As illustrated in FIGS. 14 to 17, an outdoor-unit main body 51 that is a casing is formed as a housing including a pair of left and right side surfaces 51a and 51c, a front surface 51b, a back surface 51d, a top surface 51e, and a bottom surface 51f. At the side surface 51a and the back surface 51d, opening portions are formed to allow air to be sucked from the outside. At the front surface 51b, in a front panel 52, an air outlet 53 is formed as an opening portion to allow air to be discharged to the outside. Furthermore, the air outlet 53 is covered with the fan grille 54, thereby to prevent, for example, an object located outside the outdoor-unit main body 51 from coming into contact with the axial flow fan 100 and also to ensure safety. It should be noted that an arrow AR in FIG. 15 indicates the flow of air.

The outdoor-unit main body 51 houses the axial flow fan 100 and a fan motor 61. The axial flow fan 100 is connected by a rotation shaft 62, to the fan motor 61 that serves as a drive source located close to the back surface 51d. The axial flow fan 100 is driven by the fan motor 61 to rotate. The fan motor 61 applies a drive force to the axial flow fan 100.

The interior of the outdoor-unit main body 51 is partitioned by a partition plate 51g that is a wall body into an air sending chamber 56 in which the axial flow fan 100 is provided, and a machine chamber 57 in which the compressor 64 and other components are provided. In the air sending chamber 56, a heat exchanger 68 that is substantially L-shaped as viewed in plan view is provided along the side surface 51a and the back surface 51d. It should be noted that the heat exchanger 68 operates as the condenser 72 during the heating operation, and operates as the evaporator 73 during the cooling operation.

A bell mouth 63 is located outward of the axial flow fan 100 located in the air sending chamber 56, in the radial direction. The bell mouth 63 is located outward of the outer circumferential ends of the blades 20 and has an annular shape along the rotation direction of the axial flow fan 100. The partition plate 51g is located adjacent to one of sides of the bell mouth 63, and part of the heat exchanger 68 is located adjacent to the other side of the bell mouth 63.

A front end of the bell mouth 63 is connected to the front panel 52 of the outdoor unit 50 such that the bell mouth 63 surrounds the outer circumference of the air outlet 53. It should be noted that the bell mouth 63 may be formed integrally with the front panel 52, or the bell mouth 63 and the front panel 52 may be formed as separate components such that the bell mouth 63 can be connected to the front panel 52. With this bell mouth 63, a flow passage between a suction side and an outlet side of the bell mouth 63 is formed as an air passage located in the vicinity of the air outlet 53. That is, the air passage in the vicinity of the air outlet 53 is partitioned off, by the bell mouth 63, from the other space in the air sending chamber 56.

The heat exchanger 68 provided on the suction side of the axial flow fan 100 includes a plurality of fins that have plate-like surfaces and are arranged parallel to each other, and heat transfer tubes that penetrate the fins in a direction where the fins are arranged parallel to each other. Refrigerant flows through the heat transfer tubes, and circulates in the refrigerant circuit. In the heat exchanger 68 in the embodiment, the heat transfer tubes extend to be L-shaped, along the side surface 51a and the back surface 51d of the outdoor-unit main body 51, and are arranged in a plurality of stages and curved while penetrating the fins. In addition, the heat exchanger 68 is connected to the compressor 64 by the pipe 65 or other components, and is further connected to an indoor-side heat exchanger, an expansion valve, and other components (not illustrated), thereby the refrigerant circuit 71 of the air-conditioning apparatus is formed. In the machine chamber 57, a substrate box 66 is provided. A control substrate 67 provided in this substrate box 66 controls components provided in the outdoor unit.

### Advantages of Refrigeration Cycle Apparatus 70

Since the air sending device of Embodiment 5 includes any one or more of the axial flow fans 100 to 100C, this air sending device decreases the noise level, and improves the efficiency. The air sending device is provided in an air-conditioning device or a water-heating outdoor unit that serves as the refrigeration cycle apparatus provided with the compressor 64, the heat exchanger, and other components, whereby it is possible to ensure an adequate volume of air that passes through the heat exchanger, with a low noise level and a high efficiency. Therefore, the components can achieve a low noise level and energy saving.

The configurations described above regarding the above embodiments are merely examples, and can thus be combined with another well-known technique, or partially omitted and modified without departing from the scope of the present disclosure.

1. An axial flow fan in which a plurality of blades are rotated about a rotation axis of the plurality of blades to generate an air current,
wherein each of the plurality of blades includes a leading edge portion on a forward side in a rotation direction and a trailing edge portion on a rearward side in the rotation direction,
at the trailing edge portion of the blade, a first recessed portion is formed such that the first recessed portion is recessed toward the leading edge portion,
at the leading edge portion of the blade, a second recessed portion is formed into such an arch shape as to be recessed toward the trailing edge portion, the second recessed portion including an outer circumferential end of the leading edge portion, and being recessed toward the trailing edge portion while extending inwardly from the outer circumferential end in a radial direction, and
ranges of the first recessed portion and the second recessed portion in the radial direction overlap with each other or completely coincide with each other.

2. The axial flow fan of claim 1, wherein the blade satisfies θ2>θ1, where θ1 is an angle between a straight line connecting the rotation axis and an outer circumferential end of the trailing edge portion and a straight line connecting the rotation axis and an apex of the first recessed portion, and θ2 is an angle between a straight line connecting the rotation axis and the outer circumferential end of the leading edge portion and a straight line connecting the rotation axis and an apex of the second recessed portion.

3. The axial flow fan of claim 1, wherein the blade satisfies θ2<θ1, where θ1 is an angle between a straight line connecting the rotation axis and an outer circumferential end of the trailing edge portion and a straight line connecting the rotation axis and an apex of the first recessed portion, and θ2 is an angle between a straight line connecting the rotation axis and the outer circumferential end of the leading edge portion and a straight line connecting the rotation axis and an apex of the second recessed portion.

4. The axial flow fan of claim 1, wherein the blade includes a first protruding portion that is closer to an outer circumferential side of the trailing edge portion than an apex of the first recessed portion, the first protruding portion protruding rearward in the rotation direction, and an apex of the first protruding portion is located closer to an inner circumferential side of the trailing edge portion than an outer circumferential end of the trailing edge portion, and is located more rearward in the rotation direction than the outer circumferential end of the trailing edge portion.

5. The axial flow fan of claim 1, wherein in a shape of the blade that is obtained as the blade is rotated and projected onto a meridional plane including the rotation axis, the blade includes a second protruding portion that is closer to an inner circumferential side than an apex of the first recessed portion and an apex of the second recessed portion, the second protruding portion protruding toward an upstream side of the air current.

6. An air sending device comprising:
the axial flow fan of claim 1;
a drive source configured to apply a drive force to the axial flow fan; and
a casing housing the axial flow fan and the drive source.

7. A refrigeration cycle apparatus comprising:
the air sending device of claim 6; and
a refrigerant circuit including a condenser and an evaporator,
wherein the air sending device is configured to send air to at least one of the condenser and the evaporator.
